(19) United States
(12) Patent Application Publication
(10) Pub. No.: US 2012/0158428 A1
(43) Pub. Date: Jun. 21, 2012

(54) DYNAMIC PATIENT DATA MONITORING SYSTEM AND METHOD

(75) Inventor: Sridhar Nuthi, Sussex, WI (US)

(73) Assignee: GENERAL ELECTRIC COMPANY, Schenectady, NY (US)

(21) Appl. No.: 12/970,542

(22) Filed: Dec. 16, 2010

(51) Int. Cl. G06Q 50/00; G06Q 10/00

(52) U.S. Cl. 705/3

(57) ABSTRACT

In one embodiment, a method for monitoring patient data in a medical institution is provided and includes associating at least one physiological data sensor with a patient identification device worn by a patient. The physiological data generated by the physiological data sensor is transmitted to a patient area network receiver. The patient identification device generates patient identification data and transmits it to the patient area network receiver. The physiological data is associated with the patient identification data in an electronic patient record.

### BACKGROUND OF THE INVENTION

The subject matter disclosed herein relates generally to patient monitoring systems, and, more particularly, to a dynamic patient data monitoring system and method.

Healthcare professionals monitor the locations and status of patients to control or cure medical conditions. Often electronic sensors are attached to a patient to provide continuous monitoring. The electronic sensors may gather physiological data from the patient, store the data or send it to a connected or networked storage system, process the data, and where desired present the data on a screen or chart for monitoring. In addition, the physiological data may also be stored for future reference and analysis.

Many electronic sensors use cables to connect the sensors to processing devices. As the number of electronic sensors monitoring a patient increases, managing the cable connections and quantity of cables can become difficult, particularly insomuch as the sensors may be part of disparate monitoring systems and may collect information for different purposes. In addition, when a patient needs to move from one location to another, continuous monitoring may not be possible because cables have to be disconnected. Thus, wireless sensors are beginning to replace wired sensors to avoid these complexities. As may be appreciated, other complexities may arise when wireless sensors are used. For example, it may be difficult to manage the wireless data emitted from the wireless sensors. Furthermore, it may be difficult to monitor the patient physiological data as the patient moves through a hospital or other care facility. Therefore, it may be desirable to have a monitoring system that enables wireless sensors to be managed more simply, and a system that enables a healthcare professional to monitor patient data as the patient moves through the institution.

### BRIEF DESCRIPTION OF THE INVENTION

In one embodiment, a method for monitoring patient data in a medical institution includes associating at least one physiological data sensor with a patient identification device worn by a patient and transmitting physiological data generated by the physiological data sensor to a patient area network receiver. The data monitoring method also includes transmitting patient identification data generated by the patient identification device to the patient area network receiver and associating the physiological data with the patient identification data in an electronic patient record.

In another embodiment, a system for monitoring patient data in a medical institution includes a patient identification device configured to be worn by a patient and at least one physiological data sensor configured to be associated with the patient identification device. The patient data monitoring system also includes a patient area network receiver configured to receive physiological data generated by the physiological data sensor and to receive patient identification data generated by the patient identification device. The monitoring system also includes an association logic configured to associate the physiological data with the patient identification data in an electronic patient record.

In a further embodiment, a system for monitoring patient data in a medical institution includes a patient identification device configured to be worn by a patient and at least one physiological data sensor configured to be associated with the patient identification device. The patient data monitoring system also includes a patient data access device configured to be worn by the patient and to receive physiological data from the physiological data sensor. The monitoring system includes a patient area network receiver configured to receive physiological data from the patient data access device and to receive patient identification data generated by the patient identification device. The patient data monitoring system also includes an association logic configured to associate the physiological data with the patient identification data in an electronic patient record.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a patient data monitoring system with physiological data sensors in accordance with aspects of the present disclosure;

FIG. 2 is a block diagram of a patient data monitoring system with a patient data access device;

FIG. 3 is a block diagram of a patient data monitoring system with physiological data sensors transmitting data directly to patient area network receivers;

FIG. 4 is a block diagram of a patient data monitoring system illustrating a second group of physiological data sensors on a second patient;

FIG. 5 is a diagram of patient area network receiver coverage in a medical institution; and

FIG. 6 is a flow chart of a method for monitoring patient data in a medical institution.

### DETAILED DESCRIPTION OF THE INVENTION

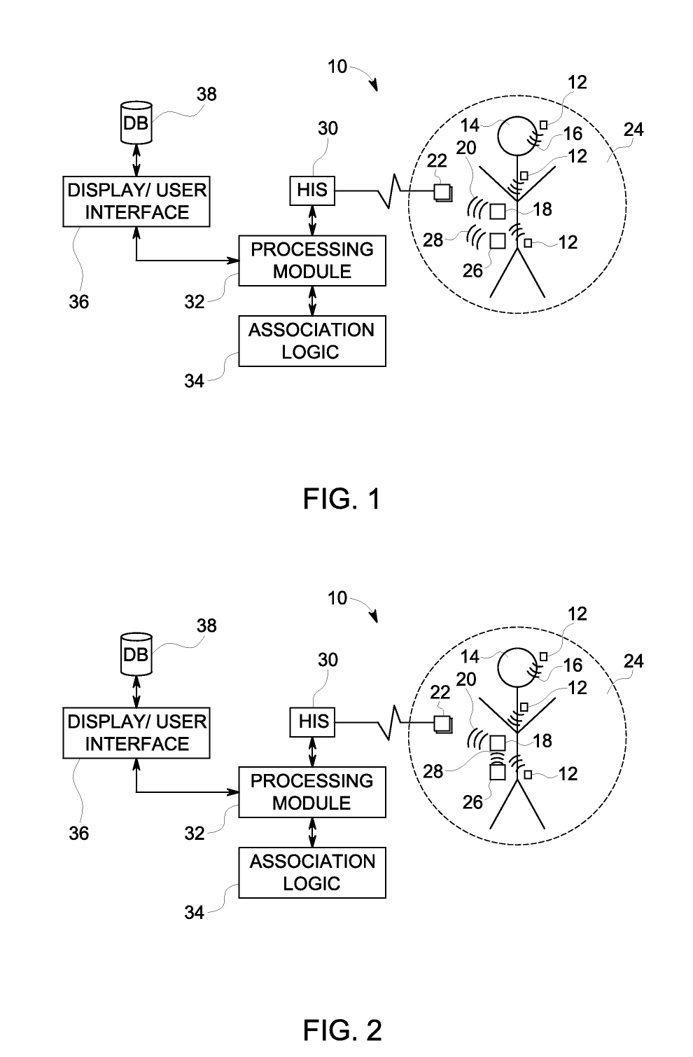

FIG. 1 is a block diagram of a patient data monitoring system 10 that uses physiological data sensors 12 to obtain physiological data to be monitored. The physiological data sensors 12 may be placed on or about a patient 14 to detect certain parameters of interest that may be indicative of medical events or conditions. Thus, the sensors 12 may detect electrical signals emanating from the body or portions of the body, pressure created by certain types of movement (e.g. pulse, respiration), or parameters such as movement, reactions to stimuli, and so forth. The sensors 12 may be placed on external regions of the body, but may also include placement within the body, such as through catheters, injected or ingested means, capsules equipped with transmitters, and so forth.

As may be appreciated, even though three sensors 12 are depicted, many such sensors 12 (and sensor assemblies) may be attached to the patient 14. For example, with electrocardiography (ECG) 3, 5, 8, 12, 20, or more sensors 12 may be attached to the patient 14. The physiological data sensors 12 transmit signals 16 or data representative of the sensed physiological data. The signals 16 may be transmitted from the sensors 12 to a patient data access device 18. The sensors 12 may transmit the signals 16 using any available protocol, such as ZigBee, Wi-Fi, or any known or later developed data transmission standard.

The physiological data sensors 12 may be organized into groups of sensors based on a particular function that the sensor group performs. For example, sensors for an electroencephalography (EEG) may be combined together as a group of sensors. The data sensors 12 may be manufactured with internal control circuitry that specifies to which functional group the sensors 12 belong or the sensors 12 may be programmed, scanned, or switched to be organized into functional groups. For example, the data sensors 12 may be manufactured for a particular group and contain a group identifier stored at a protocol or hardware level. The group identifier may be transmitted within the wireless signals sent from the sensor 12. Alternatively, the data sensors 12 may be configured to receive wireless signals to program them to be associated with a particular group, each sensor 12 may have a bar code or other identifying device that enables the sensors to be scanned and assigned to a group, or each sensor 12 may have a switch on its surface that can be adjusted to specify a group assignment. As will be appreciated by those skilled in the art, for certain physiological parameters, knowing the group or type of sensor or sensing system may be quite useful and even necessary to determine how the data collected is to be processed. By way of example, a number of different systems (e.g., cardiac monitors, blood pressure monitors, etc.) may collect pulse rate data, although the data collected by one such system may not be suitable for processing by another.

Furthermore, the sensors 12 may be bound (i.e., data linked) to the patient data access device 18 such as through a binding sequence or through data entry. For example, a group of sensors 12 may be placed near a patient data access device 18. Then a binding button or binding button sequence on the data access device 18 may be activated to link the nearby sensors to the patient data access device 18, such as in a “handshake” procedure of a type generally known in other contexts. Alternatively, the patient data access device 18 may include buttons to enable a user to manually enter, add, change, or delete sensors 18 linked to the device.

The patient data access device 18 is a device that may be worn by the patient 14 to receive signals 16 that include physiological data from each of the sensors 12 attached to the patient 14. As such, the patient data access device 18 may act as a central receiver to manage the data from the sensors 12. For example, the data access device 18 may receive and manage signals from as few as a single or few sensors, to as many as 10, 15, 30, 50, 100, or more sensors 12. The data access device 18 may be powered by a battery pack and be completely wireless to enable patient mobility. With the access device 18 located on the patient 14, signals 16 from the sensors 12 may only need to be transmitted a few feet to reach the data access device 18, such as transmissions less than six feet. Thus, sensors 12 limited to short range transmissions may be used with the patient data access device 18.

The patient data access device 18 may transmit signals 20 including the physiological data to patient area network (PAN) receivers 22. Again, the signals 20 may be transmitted from the patient device 18 using any available protocol, such as ZigBee, Wi-Fi, or any suitable data transmission standard. As illustrated, one or more PAN receivers 22 may be used to receive data. With multiple receivers 22, one receiver may be configured to receive Wi-Fi signals, while other receivers may be configured to receive RF, infrared, ZigBee, or another type of signal. That is, different receivers may use different data transmission techniques.

A reception range 24 of the PAN receivers 22 is depicted. As should be appreciated, the PAN receivers 22 may only receive signals from devices if the signal transmissions originate within the particular reception range 24. Furthermore, the size of the reception range 24 may vary depending on the type of protocol or transmission being used by the transmitter.

A patient identification device 26 may be worn by the patient 14 to provide patient identification data. The identification device 26 may be an identification tag or another type of electronic device. The identification device 26 may transmit a signal 28 that includes the patient identification data to the PAN receivers 22. The signal 28 may be transmitted via RF, infrared, Wi-Fi, ZigBee, or any other suitable manner. In addition, the identification device 26 may contain a code that can be scanned to record which device 26 is assigned to the patient 14. In one embodiment, a serial number or unique code on the identification device 26 may be manually entered into a record containing which device 26 is assigned to the patient 14.

Furthermore, the identification device 26 may be associated with the physiological data sensors 12. For example, the patient data access device 18 may wirelessly scan for any device 26 and sensors 12 within its reception range. The access device 18 may then request a verification that the devices 26 and sensors 12 detected are associated with the patient 14. Once configured, the patient data access device 18 may include a code in the signals it sends to represent the association between the identification device 26 and the sensors 12. In another embodiment, the association between the identification device 26 and the physiological data sensors 12 may be created when sensor serial numbers or unique codes are manually entered into a record that includes the patient identification device identifier.

The PAN receivers 22 receive the patient identification data and the physiological data and send the data to an institution information system, such as a hospital information system 30. The hospital information system 30 coordinates the processing and storing of the patient data. The hospital information system 30 may include a processing module 32 for processing patient data. The processing module 32 receives the data and performs processing functions, which may include simple or detailed analysis of the data. Furthermore, the processing module 32 may use association logic 34 to decode electronic signals that associate the physiological data with the patient identification data in order to create or supplement an electronic patient record. A display/user interface 36 permits the data to be manipulated, viewed, and output in a user-desired format, such as in traces on screen displays, hardcopy, and so forth. The processing module 32 may also mark or analyze the data for marking such that annotations, delimiting or labeling axes or arrows, and other indicia may appear on the output produced by interface 36. Finally, a database 38 serves to store the electronic patient records either locally within the resource, or remotely. The database 38 may also permit reformatting or reconstruction of the data, compression of the data, decompression of the data, and so forth.

To summarize the movement of data through the patient data monitoring system 10, the sensors 12 monitor the patient 14 and transmit physiological data to the patient data access device 18. The patient data access device 18 transmits the physiological data to the PAN receivers 22. In addition, the patient identification device 26 transmits patient identification data to the PAN receivers 22. The PAN receivers 22 transfer the physiological data and the patient identification data to the hospital information system 30 where it is associated into a record and may be stored in a database 38.

FIG. 2 is a block diagram of the patient data monitoring system 10 with a patient data access device 18. As in FIG. 1, physiological data sensors 12 monitor the patient 14 and transmit signals 16 containing the physiological data to the patient data access device 18. Also, the patient data access device 18 transmits signals 20 to the PAN receivers 22. However, in this embodiment, the patient identification device 26 transmits signals 28 directly to the patient data access device 18 as illustrated. Therefore, the patient data access device 18 may transmit the physiological data and the patient identification data to the PAN receivers 22. As may be appreciated, the patient data access device 18 may function completely as a central receiver for all other sensors and devices attached to the patient 14. In addition, the patient data access device 18 is enabled to associate the physiological data sensors 12 with the patient identification device 26, such as by methods previously described. Furthermore, in certain embodiments, the patient identification device 26 may only need to have a short range transmission capability.

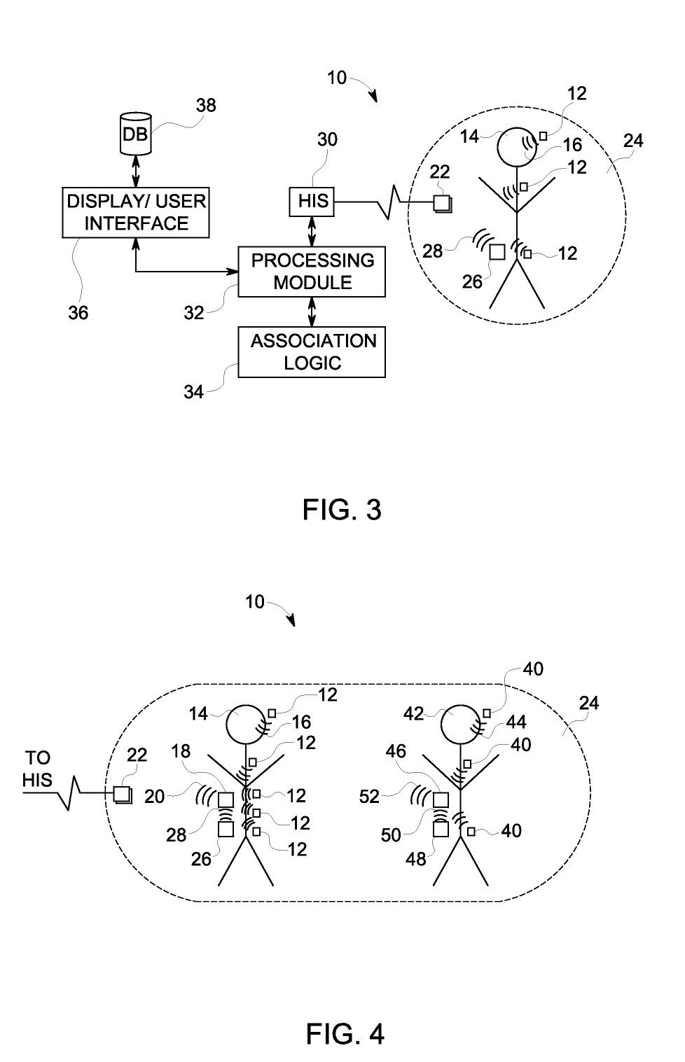

FIG. 3 is a block diagram of the patient data monitoring system 10 with physiological data sensors 12 transmitting data to PAN receivers 22. As illustrated, the physiological data sensors 12 may transmit physiological data directly to the PAN receivers 22. Likewise, the patient identification device 26 may transmit patient identification data directly to the PAN receivers 22. In such a configuration, the sensors 12 and the identification device 26 may be associated with each other via manual data entry, or another grouping method previously described.

FIG. 4 is a block diagram of the patient data monitoring system 10 illustrating a second group of physiological data sensors 40 on a second patient 42. The first patient 14, with sensors 12, the patient data access device 18, and the patient identification device 26, is illustrated with the sensors 12 and the patient identification device 26 transmitting signals 16 and 28 to the patient data access device 18. The patient data access device 18 transmits signals 20 containing the physiological data and the patient identification data from this patient 14. In addition, the second group of physiological data sensors 40 is depicted on the second patient 42. Like other embodiments previously described, the sensors 40 transmit signals 44 containing physiological data to a second patient data access device 46. Likewise, a second patient identification device 48 transmits signals 50 containing patient identification data to the second patient data access device 46. The second patient data access device 46 transmits signals 52 containing the physiological data and the patient identification data obtained from the second patient 42 to the PAN receivers 22.

As should be understood, for the PAN receivers 22 to receive transmissions from the patient data access devices 18 and 46, both devices should be within the reception range 24 of the PAN receivers 22. The PAN receivers 22 may be able to differentiate between signals received from devices 18 and 46 by unique device identifiers located in the signals sent from the devices 18 and 46. Furthermore, when patients 14 and 42 are near each other, the signals from the second sensors 40 and from the second patient identification device 48 may be detected by the first patient data access device 18. Conversely, the signals from the first sensors 12 and from the first patient identification device 26 may be detected by the second patient data access device 46. Therefore, the procedure described previously of binding sensors and a patient identification device to the patient data access device of a particular patient may enable the patient data access device to reject signals that it detects from a sensor or device to which it is not bound.

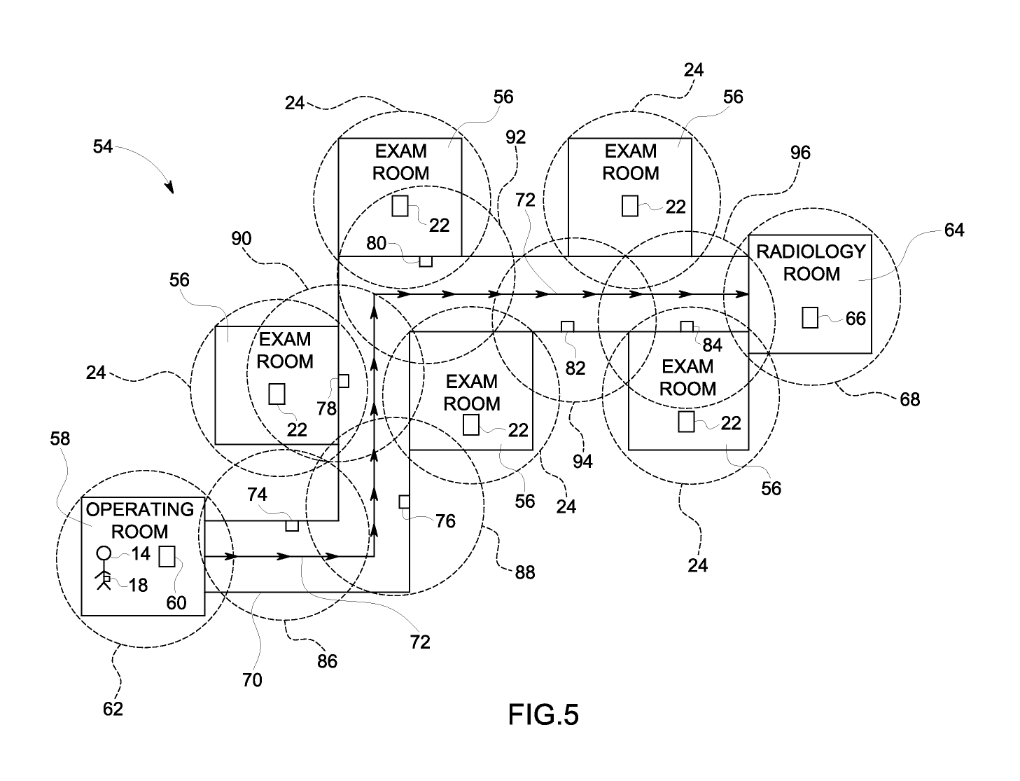

FIG. 5 is a diagram of PAN receiver coverage 54 in a medical institution. The illustration depicts how PAN receivers 22 may be positioned throughout the medical institution to maintain reception coverage for locations where the patient 14 may be monitored. Exam rooms 56 may be located at various places within the medical institution. The exam rooms 56 may each contain PAN receivers 22 to enable reception of data within the rooms. Likewise, each of the receivers 22 has an associated reception range 24 where the receivers 22 are expected to be able to receive signals sent from devices on the patient 14.

An operating room 58 is also depicted including a receiver 60 with a reception range 62. In addition, a radiology room 64 is depicted with a receiver 66 having a reception range 68. A hallway 70 extends between the operating room 58 and the radiology room 64. A patient care path 72 is illustrated with arrows depicting a potential patient travel path from the operating room 58 to the radiology room 64. Throughout the hallway, PAN receivers 74, 76, 78, 80, 82, and 84 are positioned to provide reception coverage. The reception ranges 86, 88, 90, 92, 94, and 96 of the hallway receivers extend throughout the hallway with overlapping areas that enable continuous coverage along the care path 72.

The following description demonstrates how continuous coverage may occur along the care path 72. The patient 14 with the patient data access device 18 may begin in the operating room 58. Within the operating room 58, the receiver 60 receives signals from the device 18. As the patient 14 leaves the operating room 58 and travels onto the care path 72, the patient 14 enters a coverage area 86 where receiver 74 receives signals from the device 18. As shown, coverage areas 62 and 86 overlap so that for certain locations both receivers 60 and 74 may receive signals from the device 18. This redundancy may enable continuous coverage as the patient moves along the patient care path 72. As illustrated, the patient care path 72 alternates between areas with one receiver coverage and areas with an overlap in receiver coverage. For example, the coverage for receivers 76 and 74 overlaps where coverage areas 88 and 86 overlap. Likewise, the coverage for receivers 82 and 84 overlaps where coverage areas 94 and 96 overlap. Furthermore, as the patient moves from the care path 72 to the radiology room, the coverage for receivers 84 and 66 overlaps as shown by coverage areas 96 and 68.

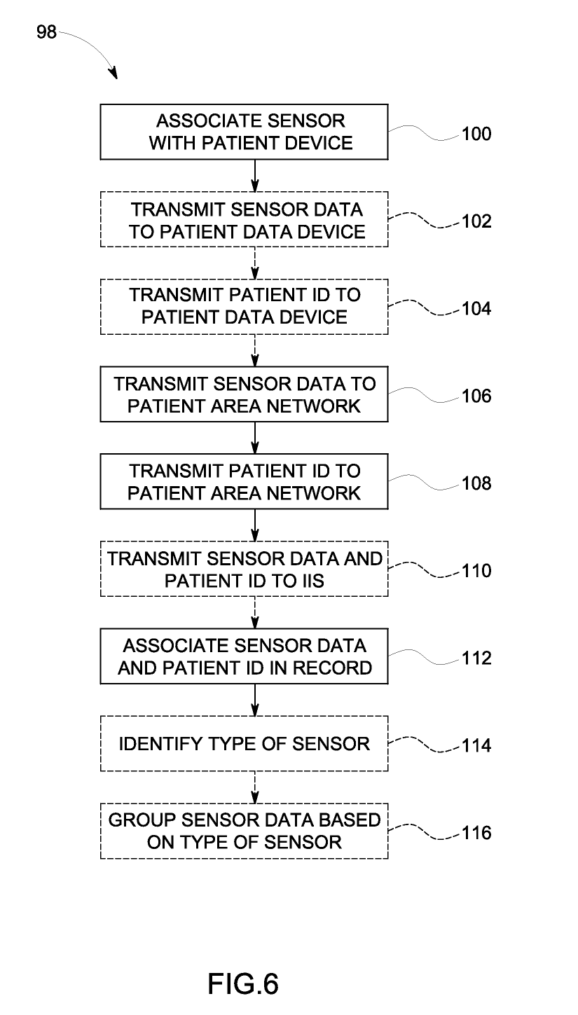

FIG. 6 is a flow chart of a method for monitoring patient data 98 in a medical institution. It should be noted that the steps described below may be completed in any appropriate order Likewise, some steps described are optional, while other steps may be added.

At step 100, at least one physiological data sensor is associated with a patient identification device that may be worn by a patient. The sensor may be associated with the identification device through manual data entry, or through binding sequences described previously. Next, at step 102, physiological data generated by the physiological data sensor may be transmitted to a patient data access device. Then, at step 104, patient identification data generated by the patient identification device may be transmitted to the patient data access device. At step 106, the physiological data is transmitted either from the patient data access device, or from the physiological data sensor to a PAN receiver, depending on whether step 102 was performed. Next, at step 108, the patient identification data is transmitted either from the patient data access device, or from the patient identification device to the PAN receiver, depending on whether step 104 was performed. As may be appreciated, different PAN receivers may receive the data as the patient moves through the medical institution.

At step 110, the physiological data and the patient identification data may be transmitted to an institution information system, such as a hospital information system. Then, at step 112, the physiological data may be associated with the patient identification data and stored in an electronic patient record, such as by the institution information system. The association may occur by the data being electronically bundled together by the patient data access device, or by unique identifiers being inserted within the physiological and identification data to create the association, for example.

At step 114, a type of sensor that generates physiological data is identified. For example, a sensor may be identified as a sensor used to perform an EEG or an ECG. Next, at step 116, the physiological data may be grouped together based on the type of sensor that monitored the data. For example, sensors relating to an EEG may be grouped together, while sensors relating to an ECG may be grouped separately. In addition, the type of sensor that generated physiological data may be recorded in the electronic patient record.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for monitoring patient data in a medical institution, comprising:
associating at least one physiological data sensor with a patient identification device worn by a patient;
transmitting physiological data generated by the physiological data sensor to a patient area network receiver;
transmitting patient identification data generated by the patient identification device to the patient area network receiver; and
associating the physiological data with the patient identification data in an electronic patient record.

2. The method of claim 1, comprising transmitting the physiological data and the patient identification data to different patient area network receivers as the patient moves through the medical institution.

3. The method of claim 1, comprising transmitting the physiological data and the patient identification data from the patient area network to an institution information system in which the electronic patient record is stored.

4. The method of claim 1, comprising transmitting the physiological data to a patient data access device worn by the patient, and transmitting the physiological data from the patient data access device to the patient area network receiver.

5. The method of claim 4, comprising transmitting the patient identification data to the patient data access device, and transmitting the patient identification data from the patient data access device to the patient area network receiver.

6. The method of claim 1, comprising identifying a type of sensor that generates the physiological data, and grouping the physiological data based upon the type of sensor.

7. The method of claim 6, comprising entering the type of sensor that generates the physiological data in the electronic patient record.

8. A system for monitoring patient data in a medical institution, comprising:
a patient identification device configured to be worn by a patient;
at least one physiological data sensor configured to be associated with the patient identification device;
a patient area network receiver configured to receive physiological data generated by the physiological data sensor and to receive patient identification data generated by the patient identification device; and
an association logic configured to associate the physiological data with the patient identification data in an electronic patient record.

9. The system of claim 8, wherein the patient identification device is associated with the physiological data sensor by scanning a code on the device and sensor.

10. The system of claim 8, wherein the physiological data and the patient identification data are transmitted to different patient area network receivers as the patient moves through the medical institution.

11. The system of claim 8, comprising an institution information system configured to receive the physiological data and the patient identification data from the patient area network and to store the electronic patient record.

12. The system of claim 8, comprising a patient data access device configured to be worn by the patient and to receive the physiological data, and configured to transmit the physiological data to the patient area network receiver.

13. The system of claim 12, wherein the patient data access device is configured to receive the patient identification data, and transmit the patient identification data to the patient area network receiver.

14. The system of claim 13, wherein the patient data access device is configured to associate the at least one physiological data sensor and the patient identification device with the patient.

15. The system of claim 8, wherein the association logic identifies a type of sensor that generates the physiological data, and groups the physiological data based upon the type of sensor.

16. The system of claim 15, wherein the electronic patient record includes the type of sensor that generates the physiological data.

17. A system for monitoring patient data in a medical institution, comprising:
a patient identification device configured to be worn by a patient;
at least one physiological data sensor configured to be associated with the patient identification device;
a patient data access device configured to be worn by the patient and to receive physiological data from the physiological data sensor;
a patient area network receiver configured to receive physiological data from the patient data access device and to receive patient identification data generated by the patient identification device; and
an association logic configured to associate the physiological data with the patient identification data in an electronic patient record.

18. The system of claim 17, wherein the physiological data and the patient identification data are transmitted to different patient area network receivers as the patient moves through the medical institution.

19. The system of claim 17, comprising an institution information system configured to receive the physiological data and the patient identification data from the patient area network and to store the electronic patient record.

20. The system of claim 17, wherein the patient data access device is configured to receive the patient identification data, and transmit the patient identification data to the patient area network receiver.
